(19) United States
(12) Patent Application Publication
(10) Pub. No.: US 2025/0243002 A1
(43) Pub. Date: Jul. 31, 2025

(54) FORK APPARATUS AND WAREHOUSING ROBOT

(71) Applicant: HAI ROBOTICS CO., LTD., Shenzhen (CN)

(72) Inventors: Qingxin ZHAN, Shenzhen (CN); Xiaodong ZHANG, Shenzhen (CN)

(73) Assignee: HAI ROBOTICS CO., LTD., Shenzhen (CN)

(21) Appl. No.: 19/183,689

(22) Filed: Apr. 18, 2025

Related U.S. Application Data
(63) Continuation of application No. PCT/CN2023/136819, filed on Dec. 6, 2023.

(30) Foreign Application Priority Data
Dec. 30, 2022 (CN) 202211730507.3

(51) Int. Cl. B65G 1/127; B65G 1/137; B65G 61/00

(52) U.S. Cl. CPC B65G 1/127; B65G 1/1373; B65G 61/00

(57) ABSTRACT

This application relates to a fork apparatus and a warehousing robot. The fork apparatus includes a fork body, including a base, a tray supported on the base, and a telescopic assembly, where the tray is supported on the base, and the telescopic assembly includes a connection member that is stretchable or retractable relative to the tray along a goods moving direction; and a goods retrieval mechanism, where the goods retrieval mechanism is detachably mounted to the connection member. The goods retrieval mechanism includes: a first goods retrieval mechanism, where the first goods retrieval mechanism includes a first goods retrieval member that operates on goods in a first manner; or a second goods retrieval mechanism, where the second goods retrieval mechanism includes a second goods retrieval member that operates on goods in a second manner different from the first manner.

### CROSS-REFERENCES

This application a continuation application of International Patent Application No. PCT/CN2023/136819 filed on Dec. 6, 2023, which claims priority to CN202211730507.3, filed on Dec. 30, 2022, the disclosures of which are incorporated herein by reference in their entireties.

### TECHNICAL FIELD

This application relates to the field of warehousing device technologies, and in particular, to a fork apparatus and a warehousing robot.

### BACKGROUND OF THE INVENTION

With the development of warehousing and logistics industries, carrying of warehousing goods containers is generally implemented by a transport robot, and the transport robot can greatly improve carrying efficiency of warehousing and logistics.

In the related art, the transport robot can only be used in a scenario where goods containers have the same size specification. In a scenario with goods containers of different sizes, since the goods containers are generally placed based on a maximum goods container size during retrieval and storage of the goods containers through a fork of the transport robot, the fork of the transport robot is hardly adapted to goods containers of small sizes, resulting in an excessively large spacing between the goods containers, reducing a warehousing density, and increasing warehousing costs. In addition, in the related art, since the fork of the transport robot can only take or place the goods containers with the same specification, it is difficult for the fork to transport the goods containers with different specifications.

### SUMMARY OF THE INVENTION

In order to resolve or partially resolve the problem existing in the related art, this application provides a fork apparatus and a warehousing robot, so that different goods retrieval mechanisms can be conveniently replaced on a fork body, reducing a difficulty of carrying goods with different specifications.

According to a first aspect of this application, a fork apparatus is provided, including:
a fork body, including a base, a tray supported on the base, and a telescopic assembly, where the tray is supported on the base, and the telescopic assembly includes a connection member that is stretchable or retractable relative to the tray along a goods moving direction; and
a goods retrieval mechanism, where the goods retrieval mechanism is detachably mounted to the connection member. The goods retrieval mechanism includes: a first goods retrieval mechanism, where the first goods retrieval mechanism includes a first goods retrieval member that operates on goods in a first manner; or a second goods retrieval mechanism, where the second goods retrieval mechanism includes a second goods retrieval member that operates on goods in a second manner different from the first manner.

In an implementation, the first goods retrieval mechanism includes a claw assembly, and/or

the second goods retrieval mechanism includes a suction cup assembly.

In an implementation, the first goods retrieval member and/or the second goods retrieval member operates on a surface of the goods facing a single direction.

In an implementation, the first goods retrieval member operates on a surface of the goods facing a single direction, and the second goods retrieval member operates on surfaces of the goods facing at least two directions respectively.

In an implementation, two telescopic assemblies are arranged. The two telescopic assemblies are respectively arranged on two sides of the tray. The two sides of the tray are respectively provided with the two telescopic assemblies and the two connection members.

Each of the telescopic assemblies is driven by a telescopic driving member through a telescopic transmission mechanism, and the telescopic transmission mechanisms of the telescopic assemblies on the two sides of the tray are synchronously driven by a single telescopic driving member.

In an implementation, the first goods retrieval mechanism is detachably mounted to a first mounting bracket, the second goods retrieval mechanism is detachably mounted to a second mounting bracket, and the first mounting bracket and the second mounting bracket are each provided with a mounting portion mated with the connection member; or the first goods retrieval mechanism or the second goods retrieval mechanism is detachably mounted to a third mounting bracket, and the third mounting bracket is provided with a mounting portion mated with the connection member on each of the two sides of the tray.

In an implementation, the telescopic assembly includes a second guide rail arranged along the goods moving direction. The connection member is connected to a second sliding member in sliding fit with the second guide rail, and the connection member is slidably connected to the tray through the second sliding member.

In an implementation, the telescopic transmission mechanism includes a belt transmission mechanism, the belt transmission mechanism includes a telescopic driving wheel, a telescopic driven wheel, and a synchronous belt wound around the telescopic driving wheel and the telescopic driven wheel, the telescopic driving wheel is connected to an output shaft of the telescopic driving member, a linear operation portion moving along the goods moving direction is formed on the synchronous belt, and the second sliding member is connected to the linear operation portion.

In an implementation, the telescopic assembly includes a first guide rail and a second guide rail arranged in parallel along the goods moving direction, the connection member is slidably connected to the tray through the first guide rail and the first sliding member in sliding fit with the first guide rail, and the tray is slidably connected to the base through the second guide rail and the second sliding member in sliding fit with the second guide rail.

In an implementation, a linkage assembly is arranged between the goods retrieval mechanism and the tray, and the goods retrieval mechanism drives the tray to stretch and/or retract through the linkage assembly during stretching and/or retracting. A linkage assembly is arranged between the goods retrieval mechanism and the tray, and the goods retrieval mechanism drives the tray to stretch and/or retract through the linkage assembly during stretching and/or retracting.

In an implementation, the linkage assembly includes two linkage trigger members arranged on the tray; and a linkage fitting member fixedly arranged relative to the goods retrieval mechanism.

The two linkage trigger members are respectively arranged on two ends of the tray along the goods moving direction, and the linkage fitting member is located between the two linkage trigger members. When moving to a preset position along a stretching or retraction direction with the goods retrieval mechanism, the linkage fitting member is configured to abut against the corresponding linkage trigger member to drive the tray to stretch or retract.

In an implementation, the fork apparatus further includes a locking mechanism arranged between the tray and the base. The locking mechanism includes a link assembly arranged on the tray and a locking member arranged on the link assembly. The locking member is configured to be locked to or separated from the base. The two linkage trigger members are arranged on the link assembly. When abutting against each of the two linkage trigger members, the linkage fitting member drives the link assembly to move along the stretching or retraction direction, to cause the locking member to be locked to or separated from the base.

In an implementation, the fork apparatus further includes an unlocking trigger member. The unlocking trigger member is in transmission fit with the locking mechanism. When the goods retrieval mechanism pulls the goods to touch the unlocking trigger member, the unlocking trigger member drives the locking mechanism to move, to cause the locking member to be unlocked from the base.

In an implementation, the base is provided with a toothed engagement plate. The toothed engagement plate is provided with several engagement teeth along the goods moving direction. When the linkage fitting member drives the link assembly to move along the stretching or retraction direction, the link assembly drives the locking member to move in a direction close to or away from the toothed engagement plate along a direction forming an included angle with the goods moving direction, so that the locking member is engaged between two adjacent engagement teeth or disengaged from the engagement teeth.

In an implementation, the link assembly includes a first link, a second link, a third link, and a fourth link rotatably connected in sequence. The first link is fixed to the tray. The two linkage trigger members are respectively arranged on the second link and the fourth link. The locking member is arranged on the first link and the third link.

Lengths of the first link and the third link are greater than lengths of the second link and the fourth link.

In some embodiments, the first goods retrieval mechanism includes a claw assembly. The claw assembly includes at least one claw. The claw is directly connected to the first mounting bracket and located between two sides of the tray to be opposite to the goods along the goods moving direction.

In an implementation, the first goods retrieval mechanism includes a claw assembly.

The claw assembly includes a claw driving member and at least one claw. The at least one claw is connected to an output shaft of the claw driving member.

The claw is arranged between the two sides of the tray above the tray, to be opposite to the goods along the goods moving direction.

The claw driving member is configured to drive the claw to ascend or descend along a vertical direction, to cause the claw to be engaged with or disengaged from the goods.

In an implementation, the second goods retrieval mechanism includes a suction cup assembly.

The suction cup assembly includes a pneumatic control assembly and at least one suction cup. The at least one suction cup is connected to the pneumatic control assembly. The pneumatic control assembly is configured to control a gas flow state in the at least one suction cup, to cause the suction cup to be attached to or detached from a goods container.

The suction cup is arranged between the two sides of the tray above the tray, to be opposite to the goods along the goods moving direction.

In an implementation, the base includes a fixing base and a rotating frame. The rotating frame is rotatably mounted to the fixing base, and the tray and the telescopic assembly are mounted to the rotating frame.

The rotating frame is driven by a rotating driving member through a rotational transmission mechanism.

The rotational transmission mechanism includes a rotating member, a rotating driving wheel, a rotating driven wheel, and a transmission member wound around the rotating driving wheel and the rotating driven wheel. The rotating frame and the fixing base are connected through the rotating member.

The rotating driving wheel is fixed to an output shaft of the rotating driving member, and the rotating driven wheel is fixedly arranged relative to the rotating frame and coaxially arranged with the rotating member.

In an implementation, the rotating driving wheel is a driving chain wheel, the rotating driven wheel is a driven chain wheel, and the rotating driving wheel and the rotating driven wheel are connected through a chain.

In an implementation, the rotational transmission mechanism further includes a tensioning apparatus. The tensioning apparatus includes a chain tensioning rod fixed to the rotating frame and a chain tensioning spring sleeved on the chain tensioning rod. One end of the chain tensioning spring is configured to abut against a mounting base of the driving chain wheel, and an other end is configured to abut against the rotating frame.

In an implementation, the rotating frame includes a rotating support plate, two fixing plates arranged on two sides of the rotating support plate, and a mounting frame arranged on an end of the rotating support plate away from the goods along the goods moving direction.

Each of the fixing plates is correspondingly equipped with the telescopic assembly, the rotating support plate is rotatably mounted to the fixing base, and/or the rotating driving member and the telescopic driving member for driving the telescopic assembly are mounted to the mounting frame. The mounting frame is further provided with a control apparatus, and the rotating driving member and the telescopic driving member are electrically connected to the control apparatus.

In an implementation, the fork apparatus further includes a tensioning adjustment mechanism. The tensioning adjustment mechanism includes a guide rod mounted to the rotating frame. A synchronous belt tensioning spring is sleeved on the guide rod. The belt transmission mechanism further includes a tensioning wheel. One end of the synchronous belt tensioning spring abuts against the rotating frame, and an other end abuts against the tensioning wheel.

According to a second aspect of this application, a warehousing robot is provided, including the fork apparatus as described above.

Technical solutions provided in this application may include the following beneficial effects.

The fork apparatus provided in this application includes a fork body, including a base, a tray supported on the base, and a telescopic assembly, where the tray is supported on the base, and the telescopic assembly includes a connection member that is stretchable or retractable relative to the tray along a goods moving direction; and a goods retrieval mechanism, where the goods retrieval mechanism is detachably mounted to the connection member. The goods retrieval mechanism includes one of the following: a first goods retrieval mechanism, where the first goods retrieval mechanism includes a first goods retrieval member that operates on goods in a first manner; and a second goods retrieval mechanism, where the second goods retrieval mechanism includes a second goods retrieval member that operates on the goods in a second manner different from the first manner. In the fork apparatus provided in the embodiments, since the first goods retrieval mechanism and the second goods retrieval mechanism are replaceably mounted to the fork body, different goods retrieval mechanisms can be conveniently replaced on the fork body. Since different goods retrieval mechanisms may be configured with the first goods retrieval member or the second goods retrieval member, the first goods retrieval member and the second goods retrieval member can operate on goods with a corresponding specification in different manners, thereby reducing the difficulty of carrying goods with different specifications.

It is to be understood that the foregoing general descriptions and the following detailed descriptions are exemplary and explanatory only; and are not intended to limit this application.

### BRIEF DESCRIPTION OF DRAWINGS

Through a more detailed description of exemplary implementations of this application with reference to the accompanying drawings, the foregoing and other objectives, features, and advantages of this application become more apparent. In the exemplary implementations of this application, the same reference numerals generally represent the same components.

FIG. 1 is a schematic structural three-dimensional view of a fork apparatus shown according to an embodiment of the present disclosure.

FIG. 2 is a schematic diagram of a bottom structure of the fork apparatus shown according to the embodiment in FIG. 1.

FIG. 3 is a partial enlarged schematic structural diagram of the fork apparatus shown according to the embodiment in FIG. 1.

FIG. 4 is a schematic structural diagram of a rotating frame of the fork apparatus shown according to the embodiment in FIG. 1.

FIG. 5 is a schematic diagram of fitting between a linkage assembly and a rotating frame of a fork apparatus shown according to an embodiment of the present disclosure.

FIG. 6 is a schematic structural diagram of a locking mechanism of a fork apparatus shown according to an embodiment of the present disclosure.

FIG. 7 is a schematic diagram of fitting between engagement teeth and a toothed engagement plate of the locking mechanism in FIG. 6.

FIG. 8 is a schematic structural diagram of a first goods retrieval mechanism of a fork apparatus according to an embodiment of the present disclosure.

FIG. 9 is a schematic structural diagram of a second goods retrieval mechanism of a fork apparatus according to an embodiment of the present disclosure.

FIG. 10 is a schematic structural diagram of a warehousing robot according to an embodiment of the present disclosure.

FIG. 11 is a simplified schematic structural diagram of a transport robot according to an embodiment of the present disclosure.

FIG. 12 shows a shelving unit with a suspended temporary storage layer according to an embodiment of the present disclosure.

FIG. 13 is a position placement diagram of a goods container on the suspended temporary storage layer in FIG. 12.

FIG. 14 is another schematic structural diagram of a suspended temporary storage layer according to an embodiment of the present disclosure.

FIG. 15 is a schematic structural diagram of a temporary storage layer of a shelving unit according to another embodiment of the present disclosure.

FIG. 16 is a schematic structural diagram of a plurality of temporary storage layers of a shelving unit according to an embodiment of the present disclosure.

FIG. 17 shows a ramp of a picking workstation according to an embodiment of the present disclosure.

FIG. 18 is a schematic structural diagram of a shelving unit and a fork apparatus according to some embodiments of the present disclosure.

FIG. 19 is a schematic structural diagram of a goods container according to some embodiments of the present disclosure.

FIG. 20a is a schematic state diagram when a goods container is placing to a storage location, showing a state that a target goods container is in contact with a first goods container.

FIG. 20b is a schematic state diagram when a goods container is placing to a storage location, showing a state that the first goods container is pushed by the target goods container for a certain distance.

FIG. 20c is a schematic state diagram when a goods container is placing to a storage location, showing a state that the target goods container pushes the first goods container while descending.

FIG. 20d is a schematic state diagram when a goods container is placing to a storage location, showing a state that a target goods container is completely located in the outermost storage location.

FIG. 21 is a schematic structural diagram of a shelving unit and a fork apparatus according to some embodiments of the present disclosure, showing that a claw of the fork apparatus is protrude out from the tray.

FIG. 22 is a schematic structural diagram of a schematic structural diagram of a shelving unit and a fork apparatus according to some embodiments of the present disclosure, showing that an abutting plate is provided on the tray.

FIG. 23 is a top view of a shelving unit provided with a guide bar according to some embodiments of the present disclosure.

Reference numerals: 100, Fixing base; 200, Rotating frame; 210, Rotating support plate; 211, Second camera; 220, Fixing plate; 221, First sliding block; 230, Toothed engagement plate; 231, Engagement teeth; 300, Rotational transmission mechanism; 600, Telescopic transmission mechanism; 310, Driving wheel; 311, Rotating member; 320, Driven wheel; 330, Chain; 340, Chain tensioning spring; 400, 42, Tray; 402, Front end surface of the tray; 410, First guide rail; 420, Second guide rail; 430, Relief groove; 440, Unlocking trigger member; 450, Connection member; 460, Second sliding block; 470, Linkage fitting member; 510, First goods retrieval module; 511, Claw driving member; 512, Claw; 513, Suction cup; 5121, Connection portion; 5122, Sliding shaft; 5123, Bearing; 520, Second goods retrieval module; 530, First mounting bracket; 531, Bracket; 540, Cover plate; 550, Second mounting bracket; 610, Telescopic driving wheel; 611, Rotating shaft; 620, Telescopic driven wheel; 630, Synchronous belt; 640, Tensioning wheel; 700, Mounting frame; 710, Rotating driving member; 720, Telescopic driving member; 711, First controller; 721, Second controller; 730, First camera; 740, Vertical plate; 750, Mounting beam; 760, Network connection device; 2221, Synchronous belt tensioning spring; 2222, Guide rod; 2223, Support; 2224, First fixing member; 800, Linkage assembly; 810, First link; 811, Second fixing member; 820, Second link; 830, Third link; 840, Fourth link; 821, Linkage trigger member; 831, Locking member; 900, Warehousing robot; 910, Chassis; 920, Lifting mechanism; 930, Storage area; 940, 40, Fork apparatus; 941, 30, 30a, 30b, 30c, 30d, Goods container; 1100, Transport robot; 1110, Movable base; 1120, Lifting mechanism; 1130, Bearing apparatus; 1200, 10, Shelving unit; 1210, High-level storage space; 1220, Low-level temporary storage space; 1222, Supporting plate; 1224, Suspension component; 1226, Beam; 1700, Ramp; 11, storage location; 31, goods retrieval portion; 32, connection part; 41, goods retrieval member; 50, beam; and 60, guide bar.

### DETAILED DESCRIPTION

Implementations of this application are to be described in more detail below with reference to the accompanying drawings. Although the implementations of this application are shown in the accompanying drawings, it is to be understood that this application may be implemented in various forms, and is not to be limited by the implementations described herein. On the contrary, these implementations are provided to cause this application to be more thorough and complete, and fully convey the scope of this application to a person skilled in the art.

Terms used in this application are merely intended to describe the specific embodiments but are not intended to limit this application. Singular forms of “a”, “said”, and “the” used in this application and the appended claims are also intended to include plural forms, unless the context clearly indicates otherwise. It is to be further understood that the term “and/or” used herein indicates and includes any or all possible combinations of one or more associated listed items. For example, “A and/or B” may include “A and B”, “only A”, or “only B”.

It is to be understood that although terms such as “first”, “second”, and “third” may be used in this application to describe various information, the information should not be limited to these terms. These terms are merely used to distinguish between information of the same type. For example, without departing from the scope of this application, first information may also be referred to as second information. Similarly, second information may also be referred to as first information. Therefore, a feature limited by “first” or “second” may explicitly or implicitly include one or more of the features. In the description of this application, “multiple” means two or more, unless otherwise explicitly and specifically defined.

In the related art, the transport robot can only be used in a scenario where goods containers have the same size specification. In a scenario with goods containers of different sizes, since the goods containers are generally placed based on a maximum goods container size during retrieval and storage of the goods containers through a fork of the transport robot, the fork of the transport robot is hardly adapted to goods containers of small sizes, resulting in an excessively large spacing between the goods containers, reducing a warehousing density, and increasing warehousing costs. In addition, in the related art, since the fork of the transport robot can only take or place the goods containers with the same specification, it is difficult for the fork to transport the goods containers with different specifications.

In view of the foregoing problem, an embodiment of this application provides a fork apparatus, so that different goods retrieval mechanisms can be conveniently replaced on a fork body, and a difficulty of carrying goods with different specifications is reduced.

The technical solutions of the embodiments of this application are described in detail below with reference to the accompanying drawings.

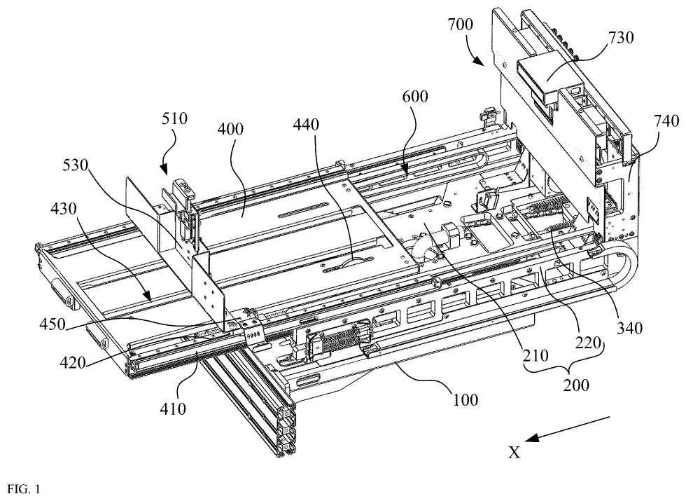

Referring to FIG. 1, the fork apparatus in some embodiments of the present disclosure includes a fork body and a goods retrieval mechanism mounted to the fork body.

The fork body includes a base, a tray 400 supported on the base, and a telescopic assembly. The tray 400 is supported by the base. The telescopic assembly includes a connection member 450 configured to connect the goods retrieval mechanism. The connection member 450 is stretchable or retractable relative to the tray 400 along a goods moving direction X.

The goods retrieval mechanism is detachably mounted to the connection member 450. The goods retrieval mechanism includes: a first goods retrieval mechanism or a second goods retrieval mechanism. The first goods retrieval mechanism includes a first goods retrieval member that operates on goods in a first manner. The second goods retrieval mechanism includes a second goods retrieval member that operates on the goods in a second manner different from the first manner. The first goods retrieval mechanism and the second goods retrieval mechanism are interchangeably installed on the connection member. The first goods retrieval mechanism or the second goods retrieval mechanism could be mounted to the connection member 450 as needed. For example, in some scenarios where the first goods retrieval mechanism is required for retrieving goods, the first goods retrieval mechanism is mounted to the connection member 450. In other scenarios where the second retrieval mechanism is required, the first retrieval mechanism is removed and replaced with the second retrieval mechanism on the connection member 450. It may be understood that the goods may be, for example, but not limited to, a goods container.

In the fork apparatus provided in the embodiments, since the first goods retrieval mechanism and the second goods retrieval mechanism are replaceably mounted to the fork body, different goods retrieval mechanisms can be conveniently replaced on the fork body. Since different goods retrieval mechanisms may be configured with the first goods retrieval member or the second goods retrieval member, the first goods retrieval member and the second goods retrieval member can operate on goods with a corresponding specification in different manners, the difficulty of carrying goods with different specifications could be reduced.

In some embodiments, the first goods retrieval mechanism includes a claw assembly.

In some embodiments, the second goods retrieval mechanism includes a suction cup assembly. In some embodiments, the first goods retrieval member and/or the second goods retrieval member operates on a surface of the goods facing a single direction, for example, operates on a surface of the goods facing the goods moving direction X.

In some embodiments, the first goods retrieval member operates on a surface of the goods facing a single direction, and the second goods retrieval member operates on surfaces of the goods facing at least two directions respectively. For example, the first goods retrieval member may be a claw or a suction cup, which operates on the surface of goods facing the goods moving direction X, and the second goods retrieval member may be a clamping arm, which operates on two side surfaces of the goods facing away from each other.

In this embodiment, the base includes a fixing base 100 and a rotating frame 200. The rotating frame 200 is rotatably mounted to the fixing base 100. The tray 400 and the telescopic assembly are mounted to the rotating frame 200. A rotational transmission mechanism and a telescopic transmission mechanism 600 are further mounted to the rotating frame 200. The rotating frame 200 is driven by a rotating driving member through the rotational transmission mechanism. The goods retrieval mechanism is connected to the connection member 450, and the connection member 450 is connected to the telescopic transmission mechanism 600. The connection member 450 is movable relative to the tray 400.

In some embodiments, the fork apparatus is further provided with a driving mechanism. The driving mechanism includes a rotating driving member 710 and a telescopic driving member 720. The rotating driving member 710 is connected to the rotating frame 200 through a rotational transmission mechanism 300, so that the rotational transmission mechanism 300 drives the rotating frame 200 to rotate relative to the fixing base 100. The telescopic driving member 720 is connected to the telescopic transmission mechanism 600, to cause the telescopic transmission mechanism 600 to drive the connection member 450 to move relative to the rotating frame 200.

In some embodiments, the rotating frame 200 includes a rotating support plate 210, two fixing plates 220 arranged above the rotating support plate 210 and positioned on two sides of the rotating support plate 210, and a mounting frame 700 arranged on an end of the rotating support plate 210 away from the goods along a goods moving direction. For example, the rotating support plate 210 may include an inlet or outlet end for the goods to move into or out from the rotating support plate 210, the mounting frame 700 is positioned on another end of the rotating support plate 210 away from the inlet or outlet end. The fixing plate 220 may be connected to the rotating support plate 210 through screws. The rotating driving member and the telescopic driving member for driving the telescopic assembly are mounted to the mounting frame 700. The mounting frame 700 is further provided with a control apparatus. The rotating driving member and the telescopic driving member are electrically connected to the control apparatus. In some embodiments, the control apparatus includes a first controller 711 electrically connected to the rotating driving member 710, and a second controller 721 electrically connected to the telescopic driving member 720.

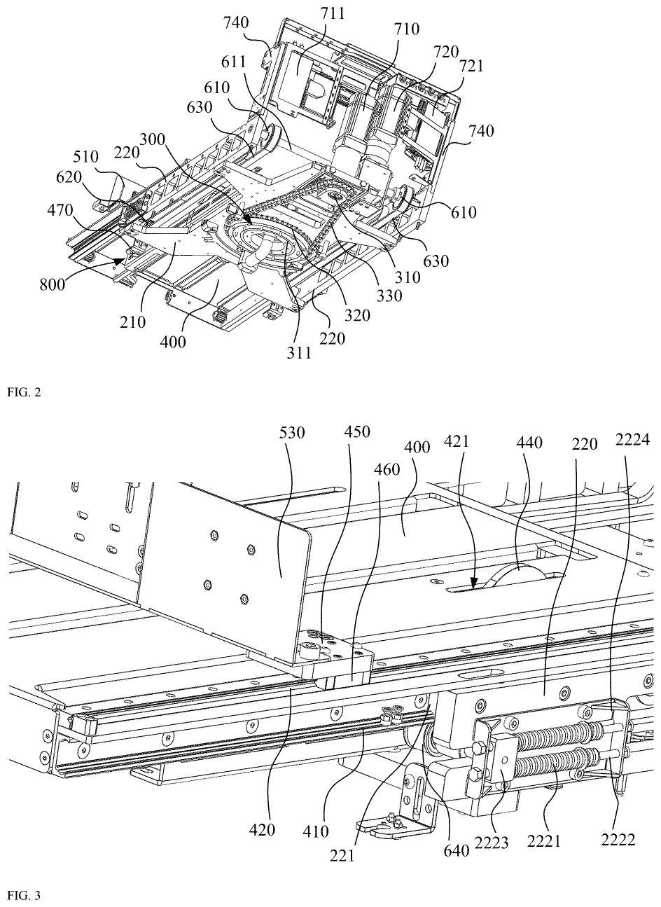

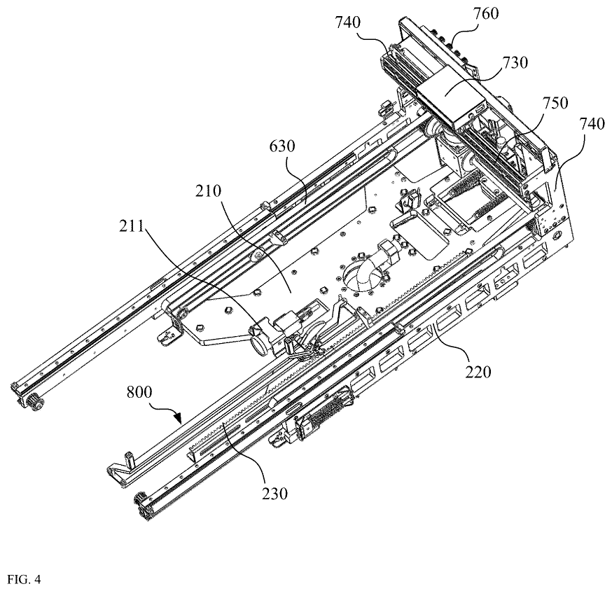

The fork apparatus in this embodiment further includes several electronic components and devices. Referring to FIG. 1, FIG. 2, and FIG. 4, the several electronic components and devices include a network connection device 760 communicatively connected to a remote control device and an image capturing device. The network connection device 760 is electrically connected to the first controller 711 and the second controller 721, and the network connection device 760 can establish a communicative connection with the remote control device, to remotely control operation of the telescopic driving member 720 and the rotating driving member 710. The network connection device 760 may include, for example, a router.

In some embodiments, the electronic components and devices further include a rotation detection switch mounted to the fixing base 100 and/or the rotating frame 200. The rotation detection switch is configured to detect a position of the rotating frame, to facilitate accurate control of the rotation of the rotating frame.

In some embodiments, the fixing base and/or the rotating frame is equipped with a rotation limiting block. The rotation limiting block is configured to limit the rotation of the rotating frame 200 within a set range, to prevent excessive rotation of the rotating frame 200.

An end of the rotating support plate 210 away from the goods along the goods moving direction is further equipped with the mounting frame 700. The mounting frame 700 includes two vertical plates 740 connected to two sides of the rotating support plate 210, and a mounting beam 750 is connected between the two vertical plates 740 (as shown in FIG. 4). The first controller 711, the second controller 721, a power controller, and the network connection device 760 may be mounted to the mounting beam 750. The image capturing device includes a first camera 730 mounted to the top of the mounting frame 700. The first camera 730 may be a scanner camera, which is configured to capture identification information of a shelving unit, a storage location, a goods container, or the like through readable code scanning.

Still referring to FIG. 4, the image capturing device further includes a second camera 211. The second camera 211 is mounted to a front of the rotating support plate 210, and a lens of the second camera 211 faces a front end of the tray 400 and may be configured to identify a position of a goods container.

In some embodiments, the electronic components and devices further include a goods container detection switch. The goods container detection switch is configured to identify a goods container occupancy signal.

In some embodiments, the rotating driving member 710 and the telescopic driving member 720 may be motors. The rotating driving member 710 and the telescopic driving member 720 are arranged in parallel along a vertical direction. The rotating driving member 710 and the telescopic driving member 720 are fixed to the mounting frame 700.

Referring to FIG. 2, the rotational transmission mechanism further includes a rotating member 311. The rotating support plate 210 of the rotating frame is connected to the fixing base 100 through the rotating member 311, and the rotating member 311 may be, for example, a bearing.

The rotating frame 200 is driven by the rotating driving member 710 through the rotational transmission mechanism 300. The rotational transmission mechanism 300 includes a rotating driving wheel 310, a rotating driven wheel 320, and a transmission member wound around the rotating driving wheel 310 and the rotating driven wheel 320. The rotating driving wheel 310 is fixed to an output shaft of the rotating driving member 710. The rotating driven wheel 320 is fixedly arranged relative to the rotating support plate 210 and is coaxial with the rotating member 311. The rotating driving wheel 310 can drive the rotating driven wheel 320 into rotation through the transmission member, thereby causing the rotating support plate 210 to rotate relative to the fixing base 100.

In some embodiments, the rotating driving wheel 310 is a driving chain wheel, the rotating driven wheel 320 is a driven chain wheel, and the transmission member may be a chain 330 wound around the driving chain wheel 310 and the driven chain wheel 320.

It may be understood that, in some other embodiments, the rotational transmission mechanism 300 may be a transmission belt transmission mechanism, a gear transmission mechanism, or the like.

In some embodiments, the rotational transmission mechanism 300 further includes a tensioning apparatus. The tensioning apparatus includes a chain tensioning rod fixed to the rotating frame and a chain tensioning spring 340 sleeved on the chain tensioning rod. One end of the chain tensioning spring is configured to abut against a mounting base of the driving chain wheel, and an other end is configured to abut against the rotating frame 200.

Referring to FIG. 1 and FIG. 2, in the specific examples shown in the figures, the rotating member 311, such as a rotating bearing, is mounted to the center of the rotating frame 200. An outer ring of the rotating bearing 311 is fixedly mounted to the fixing base 100, and an inner ring of the rotating bearing 311 is fixedly mounted to the rotating support plate 210.

A diameter of the driving chain wheel 310 is less than a diameter of the driven chain wheel 320. The driven chain wheel 320 is fixedly mounted to the rotating frame 200, for example, mounted to the rotating support plate 210. The chain tensioning rod is fixedly mounted to a rear end of the rotating support plate 210, and extends along the goods moving direction X. The chain tensioning spring 340 is sleeved on the chain tensioning rod, and the chain tensioning spring 340 is configured to be slidable on the chain tensioning rod. One end of the chain tensioning spring 340 abuts against a vertical side wall of the rotating support plate 210, and an other end abuts against the mounting base having the driving chain wheel 310 mounted thereon. The mounting base of the driving chain wheel 310 is fixedly mounted to the rotating driving member 710, and the driving chain wheel 310 is rotatably mounted to a corresponding mounting base thereof and connected to the output shaft of the rotating driving member 710 through a flat key, so as to rotate with the output shaft. When a fork needs to be rotated, the rotating driving member 710 drives the driving chain wheel 310, and the driving chain wheel 310 is connected to the driven chain wheel 320 through the chain 330, thereby realizing the rotation of the rotating frame 200 and the assemblies mounted to the rotating frame 200 relative to the fixing base 100 as a whole.

In some embodiments, the telescopic assembly further includes a second guide rail that is stretchable or retractable along the goods moving direction X. The connection member 450 is connected to a second sliding member in sliding fit with the second guide rail, and the connection member 450 is slidably connected to the tray 400 through the second sliding member, so as to slide back and forth along the goods moving direction X relative to the tray 400 under the guidance of the second guide rail, so that the goods retrieval mechanism retrieves goods from a shelving unit or places the goods on the shelving unit. The second sliding member may be a second sliding block 460.

In some embodiments, the fork body includes two sets of telescopic assemblies and telescopic transmission mechanisms 600 respectively arranged on two sides of the tray 400. The two telescopic assemblies on the two sides of the tray 400 are driven by a telescopic driving member through two telescopic transmission mechanisms 600 on the two sides of the tray 400. The two telescopic transmission mechanisms 600 are synchronously driven by a single telescopic driving member 720, or synchronously driven by respective telescopic driving members.

Referring to FIG. 2 and FIG. 3, in some embodiments, each fixing plate 220 is correspondingly equipped with a telescopic assembly; and the rotating support plate 211 is rotatably mounted to the fixing base. The two fixing plates 220 are each equipped with the telescopic transmission mechanism 600. The telescopic transmission mechanism 600 includes a belt transmission mechanism. The belt transmission mechanism includes a telescopic driving wheel 610, a telescopic driven wheel 620, and a synchronous belt 630 wound around the telescopic driving wheel 610 and the telescopic driven wheel 620. The telescopic driving wheel 610 is connected to an output shaft of the telescopic driving member 720. A linear operation portion moving along the goods moving direction X is formed on the synchronous belt 630, and the second sliding member is connected to the linear operation portion. The connection members 450 on the two sides of the tray are respectively fixed to the linear operation portions of the corresponding telescopic transmission mechanisms 600. In operation, the telescopic driving member 720 can drive the two telescopic driving wheels 610 to rotate, so as to cause the linear operation portions of the two synchronous belts 630 to move, and then the connection members 450 on the two sides of the tray 400 stretch or retract synchronously relative to the rotating frame 200.

In this embodiment, the two telescopic transmission mechanisms 600 are synchronously driven by a single telescopic driving member 720. The rotating frame 200 is provided with a rotating shaft 611, and the rotating shaft 611 is arranged on a rear end of the rotating frame 200 and extends along a second horizontal direction. Two ends of the rotating shaft 611 are rotatably connected to the two fixing plates 220. For example, a rear end of each of the two fixing plates 220 is equipped with a bearing, and the rotating shaft 611 is rotatable relative to the fixing plates 220 through the bearings on the two ends. The two telescopic driving wheels 610 are fixed to the rotating shaft 611 and are arranged close to the two ends of the rotating shaft 611. The telescopic driving member 720 and the rotating shaft 611 are drive-connected, for example, may be connected through a gear mechanism. In operation, the telescopic driving member 720 can drive the rotating shaft 611 into rotation, and drive the two telescopic driving wheels 610 into rotation through the rotating shaft 611, so that the two synchronous belts 630 of the two telescopic transmission mechanisms 600 operate synchronously.

Referring to FIG. 3, in some embodiments, the base further includes a tensioning adjustment mechanism. The tensioning adjustment mechanism includes a guide rod 2222 mounted to the rotating frame. The guide rod 2222 is mounted to a first fixing member 2224. The first fixing member 2224 is fixedly mounted to the fixing plate 220, and a synchronous belt tensioning spring 2221 is sleeved on the guide rod 2222. The belt transmission mechanism further includes a tensioning wheel 640. The tensioning wheel 640 is mounted to a support 2223. The support 2223 is slidably mounted to the fixing plate 220. One end of the synchronous belt tensioning spring 2221 abuts against the rotating frame, for example, abuts against the first fixing member 2224 on the rotating frame, and an other end abuts against the tensioning wheel 640, or may abut against the support 2223. Under the tensioning of the synchronous belt tensioning spring 2221, an automatic tensioning adjustment function of the synchronous belt can be implemented, thereby avoiding abrasion and abnormal sound caused by long-term use of the synchronous belt.

Referring to FIG. 3, the telescopic assembly in this embodiment includes a first guide rail 410 and a second guide rail 420 respectively arranged on the two sides of the tray 400. The tray 400 is slidably connected to the base through the first guide rail 410 and a first sliding member 221 in sliding fit with the first guide rail 410. The connection member 450 is slidably connected to the tray 400 through the second guide rail 420 and the second sliding member in sliding fit with the second guide rail 420.

In this embodiment, the first sliding member may be a first sliding block 221, and the second sliding member may be a second sliding block 460.

The first guide rail 410 and the second guide rail 420 are arranged in parallel along the goods moving direction X. The tray 400 is slidably connected to the fixing plate 220 of the base through the first guide rail 410 and the first sliding block 221. The connection member 450 is slidably connected to the tray 400 through the second guide rail 420 and the second sliding block 460. In this embodiment, the connection member 450 is fixed to the second sliding block 460. It may be understood that in some other embodiments, the sliding block may also be replaced by a sliding member in another form such as a pulley.

In some embodiments, the first guide rail 410 and the second guide rail 420 are both arranged on the tray 400. A guide rail connection plate may be mounted on each of the two sides of the tray 400. Each guide rail connection plate is equipped with the first guide rail 410 and the second guide rail 420.

The first guide rail 410 is in sliding fit with the first sliding block 221, and the second guide rail 420 is in sliding fit with the second sliding block 460. The first sliding block 221 is fixedly connected to the fixing plate 220. The second sliding block 460 is fixedly connected to the connection member 450. A bottom of the second sliding block 460 is provided with a synchronous belt fixing member. The synchronous belt fixing member is fixedly connected to the linear operation portion of the synchronous belt 630. The synchronous belt fixing member is, for example, a synchronous belt clamping block. When the telescopic driving member 720 drives the telescopic transmission mechanism 600 to move, the synchronous belt 630 can drive the second sliding block 460 to slide along the second guide rail 420.

Referring to FIG. 4 to FIG. 6, in this embodiment, a linkage assembly 800 is arranged between the goods retrieval mechanism and the tray 400. During stretching and/or retracting, the goods retrieval mechanism can drive the tray 400 to stretch and/or retract through the linkage assembly 800, to implement a two-stage telescopic movement.

The linkage assembly 800 includes two linkage trigger members 821 arranged on the tray 400, and a linkage fitting member 470 fixedly arranged relative to the goods retrieval mechanism (as shown in FIG. 2). The two linkage trigger members 821 are respectively arranged on a front end and a rear end of the tray 400 along the goods moving direction X. The linkage fitting member 470 is arranged at a bottom of the goods retrieval mechanism, and the linkage fitting member 470 is located between the two linkage trigger members 821.

The two linkage trigger members 821 and the linkage fitting member 470 may be arranged along a same straight line, so that the linkage fitting member 470 can abut against a corresponding linkage trigger member 821 when moving to a preset position along the stretching or retraction direction with the goods retrieval mechanism, to drive the tray 400 to stretch or retract.

Referring to FIG. 1 and FIG. 2, the tray 400 is provided with a relief groove 430 extending along the stretching or retraction direction, and the linkage fitting member 470 is fixed to a bottom of a mounting bracket of the goods retrieval mechanism and extends through the relief groove 430 to the bottom of the tray 400. When the goods retrieval mechanism 500 moves relative to the tray 400, the linkage fitting member 470 can move along the relief groove 430.

When moving forward to the preset position with the goods retrieval mechanism, the linkage fitting member 470 abuts against the linkage trigger member 821 at the front end, and pushes the linkage trigger member 821 at the front end to move forward. Since the linkage trigger member 821 at the front end is arranged on the tray 400, the goods retrieval mechanism 500 can drive the tray to move forward.

When moving backward to another preset position with the goods retrieval mechanism, the linkage fitting member 470 abuts against the linkage trigger member 821 at the rear end, and pushes the linkage trigger member 821 at the rear end to move backward. Since the linkage trigger member 821 at the rear end is arranged on the tray 400, the goods retrieval mechanism can drive the tray to move backward.

In some embodiments, the electronic components and devices further include a tray position detection switch mounted to the rotating frame 200 for detecting whether the tray 400 returns to its original position.

Referring to FIG. 5, in some embodiments, the fork apparatus further includes a locking mechanism arranged between the tray 400 and the base. The locking mechanism may be arranged between the tray 400 and the fixing plate 220 of the base. The locking mechanism includes a link assembly arranged on the tray 400 and a locking member 831 arranged on the link assembly. The locking member 831 is configured to be locked to or separated from the base. For example, the locking member 831 is locked to or separated from the fixing plate 220, and the two linkage trigger members 821 are arranged on the link assembly.

In an initial state, that is, before goods retrieval, the locking member 831 is locked to the fixing plate 220, so that the tray 400 is fixed to the fixing plate 220. In this way, in operation, the goods retrieval mechanism does not drive the tray 400 to move. When the linkage fitting member 470 moving with the goods retrieval mechanism abuts against the linkage trigger member 821, the link assembly can be driven to move along the stretching or retraction direction, and then the locking member 831 arranged on the link assembly is disengaged from the fixing plate 220, thereby unlocking the tray 400 from the fixing plate 220. After the unlocking, the goods retrieval mechanism can drive the tray 400 to move together. When the linkage fitting member 470 moving with the goods retrieval mechanism does not abut against the linkage trigger member 821, the link assembly is not driven to move along the stretching or retraction direction, and the locking member 831 is not disengaged from the fixing plate 220, thereby maintaining a locked state.

In some embodiments, a side of the base close to the locking member 831 is equipped with a toothed engagement plate 230. The toothed engagement plate 230 may be arranged on the fixing plate 220 of the base, and the toothed engagement plate 230 is provided with several engagement teeth 231 along the stretching or retraction direction (that is, the goods moving direction X) of the tray 400. When the linkage fitting member 470 drives the link assembly to move along the stretching or retraction direction, the link assembly may drive the locking member to move in a direction close to or away from the toothed engagement plate 230 along a direction forming an included angle with the goods moving direction X, so that the locking member is engaged between two adjacent engagement teeth or disengaged from the engagement teeth. When the locking member 831 is engaged between two adjacent engagement teeth 231, locking can be implemented, and when the link assembly drives the locking member 831 to be separated from the engagement teeth 231, the unlocking can be implemented. It may be understood that the included angle formed relative to the goods moving direction X may be an acute angle, a right angle, or an obtuse angle.

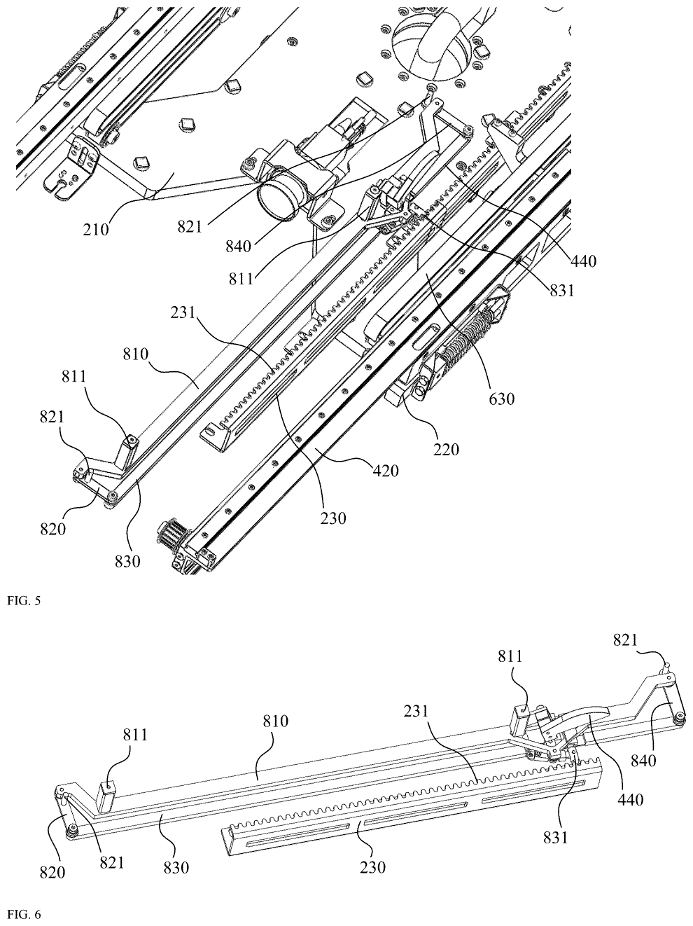

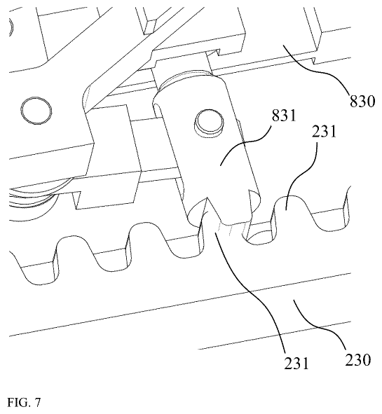

Referring to FIG. 6, the link assembly includes a first link 810, a second link 820, a third link 830, and a fourth link 840 rotatably connected in sequence. The first link 810 may be arranged along the goods moving direction X, and fixed to the bottom of the tray 400 at both ends through the second fixing member 811, and may not move relative to the tray 400. The second link 820, the third link 830, and the fourth link 840 can move relative to the tray 400. The two linkage trigger members 821 are respectively fixed to the second link 820 and the fourth link 840. The locking member 831 is arranged on the third link 830, or the locking member 831 may also be arranged on the first link 810 and the third link 830. Lengths of the first link 810 and the third link 830 are greater than lengths of the second link 820 and the fourth link 840. In some embodiments, the linkage assembly further includes an unlocking trigger member 440. The unlocking trigger member 440 is in transmission fit with the locking mechanism. When the goods retrieval mechanism pulls the goods to touch the unlocking trigger member 440, the unlocking trigger member 440 drives the locking mechanism to move, to cause the locking member 831 to be unlocked from the base.

In the embodiment shown in FIG. 3, the unlocking trigger member 440 is rotatably arranged at the bottom of the tray 400, and a rotating shaft of the unlocking trigger member 440 is parallel to an upper surface of the tray 400 for supporting a goods container, and is perpendicular to the stretching or retraction direction of the tray 400, so that the unlocking trigger member 440 may rotate up and down. The unlocking trigger member 440 is accommodated in a through groove 421 formed in the tray 400. When the goods retrieval mechanism pulls a goods container to retract on the tray 400 along the goods moving direction X, the unlocking trigger member 440 rotates downward, and then drives the locking member 831 to move, thereby unlocking the locking member 831 from the toothed engagement plate 230 on the base. When the goods are away from the unlocking trigger member 440, the unlocking trigger member 440 can rotate upward, and can stretch out of the upper surface of the tray 400 through the through groove 421.

In some embodiments, the unlocking trigger member 440 may be mounted to the link assembly at the bottom of the tray 400, for example, mounted to the first link 810. The unlocking trigger member 440 is connected to a reset elastic member, and before the goods container does not contact the unlocking trigger member 440, the unlocking trigger member 440 stretches out of the upper surface of the tray 400. The goods container moves backward on the tray 400 to touch the unlocking trigger member 440, and triggers the unlocking trigger member 440 to rotate downward.

When the tray 400 is in the initial state, the locking member 831 is engaged with the toothed engagement plate 230 of the rotating frame 200, and a spacing exists between the linkage fitting member 470 and each of the two linkage trigger members 821 in the stretching or retraction direction of the tray 400. When moving to the preset position in the stretching direction with the goods retrieval mechanism, the linkage fitting member 470 can drive the third link 830 into movement by pushing the linkage trigger member 821 at the front end, so that the third link 830 drives the locking member 831 to be disengaged from the toothed engagement plate 230, and unlocks the tray from the rotating frame, and the goods retrieval mechanism can drive the tray 400 to move together in the stretching direction.

When moving to another preset position in the retraction direction with the goods retrieval mechanism, the linkage fitting member 470 can cause the third link 830 to move by pushing the linkage trigger member 821 at the rear end, so that the third link 830 drives the locking member 831 to be disengaged from the toothed engagement plate 230, and unlocks the tray from the rotating frame, and the goods retrieval mechanism can drive the tray 400 to move together in the retraction direction.

Through such arrangement, the movement of the telescopic transmission mechanism 600 can drive the goods retrieval mechanism and the tray 400 to move successively; thereby implementing a two-stage telescopic movement. A structure of the fork apparatus may be simplified through arrangement of a single telescopic driving member to drive the telescopic assemblies on the two sides of the tray.

In some embodiments, a third mounting bracket is arranged between the connection members 450 on the two sides of the tray 400, and the first goods retrieval mechanism and the second goods retrieval mechanism are selectively detachably mounted to the third mounting bracket. The third mounting bracket may be arranged above the tray 400, and the third mounting bracket is connected to the corresponding connection member 450 on the two sides of the tray 400 in a width direction. The connection member 450 is slidably connected to the second guide rail 420 on the corresponding side through the second sliding member. For example, when the first goods retrieval mechanism needs to be replaced by the second goods retrieval mechanism, the first goods retrieval mechanism may be removed from the third mounting bracket, and then the second goods retrieval mechanism is mounted to the third mounting bracket.

In some embodiments, the first goods retrieval mechanism is mounted to a first mounting bracket 530, and the second goods retrieval mechanism is mounted to a second mounting bracket 550. The first mounting bracket 530 and the second mounting bracket 550 are each provided with a mounting portion mated with the connection member 450. The first mounting bracket 530 and the second mounting bracket 550 are selectively detachably mounted to the connection member 450. The first mounting bracket 530 and the first goods retrieval mechanism form a first goods retrieval module, and the second mounting bracket 550 and the second goods retrieval mechanism form a second goods retrieval module 520. For example, when the first goods retrieval mechanism needs to be replaced by the second goods retrieval mechanism, the first mounting bracket 530 of the first goods retrieval module may be removed from the connection member 450, and then the second mounting bracket 550 of the second goods retrieval module 520 is connected to the connection member 450.

Referring to FIG. 8, in some applications, the first goods retrieval mechanism is a claw assembly. The claw assembly includes a claw driving member 511 and at least one claw 512. The claw 512 is connected to an output shaft of the claw driving member 511, and the claw driving member 511 is configured to drive the claw 512 to move, to cause the claw 512 to be engaged with or disengaged from a preset part of a goods container.

In some embodiments, the claw assembly may not include a claw driving member. In this case, the ascending or descending of the claw could be implemented by driving the fork apparatus to ascend or descend through a lifting mechanism. Specifically, the claw may be directly connected to the first mounting bracket and located between the two sides of the tray to be opposite to the goods along the goods moving direction. In the stretching direction of the telescopic assembly; the claw protrudes from the first mounting bracket, so that when the first mounting bracket slides to a front end of the tray in the stretching direction, the claw protrudes from the tray, thereby causing the claw to be inserted into a groove of a target goods container.

In some embodiments, the claw assembly and the first mounting bracket 530 form the first goods retrieval module 510. The first mounting bracket 530 includes a push plate. When the first goods retrieval module 510 moves forward, the push plate is configured to push a goods container borne on the tray 400 out of the tray 400. A bracket 531 is fixed above the middle of the push plate, and the claw driving member 511 is fixed to the bracket 531. The claw 512 is provided with a connection portion 5121 connected to the output shaft of the claw driving member 511. The claw assembly further includes a sliding shaft 5122 and a bearing 5123. The bearing 5123 is arranged on the bracket 531, and the sliding shaft 5122 extends through the bearing 5123. The connection portion 5121 is connected to an end of the sliding shaft 5122, so as to implement a movement function of the claw 512 through sliding fit of the sliding shaft 5122 and the bearing 5123.

In this embodiment, the claw 512 is arranged above the tray 400 and located between the two sides of the tray; and the claw 512 is configured to be opposite to the goods along the goods moving direction X. In this way, the claw 512 may fetch goods by operating on a surface of the goods facing the goods moving direction X.

In some embodiments, the claw driving member 511 is arranged along a vertical direction, and the output shaft of the claw driving member 511 can move linearly along the vertical direction, thereby driving the claw 512 to ascend or descend. During the ascending, the claw 512 may be engaged with the goods container, and during the descending, the claw 512 may be disengaged from the goods container. Alternatively, during the descending, the claw 512 may be engaged with the goods container, and during the ascending, the claw 512 may be disengaged from the goods container.

In some embodiments, the claw driving member 511 may further be arranged along another direction such as a transverse direction, to drive the claw 512 to move transversely.

In some embodiments, the claw assembly further includes a driving controller. The driving controller is electrically connected to the claw driving member 511, and is configured to control an operating state of the claw driving member 511.

In some embodiments, the claw driving member 511 may be an electric push rod. The output shaft of the claw driving member 511 may be a telescopic shaft of the electric push rod.

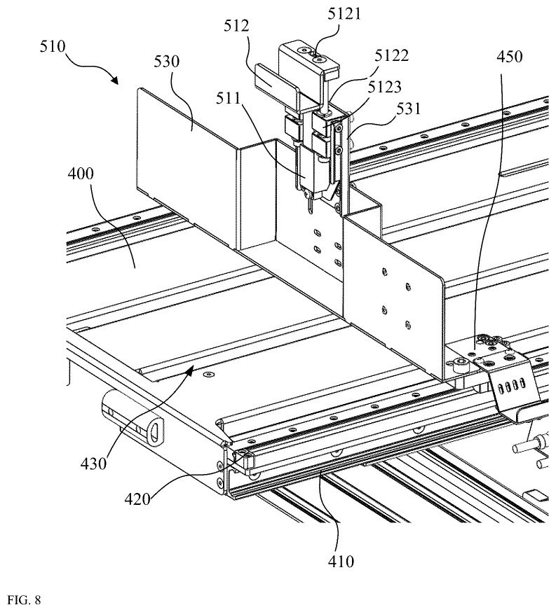

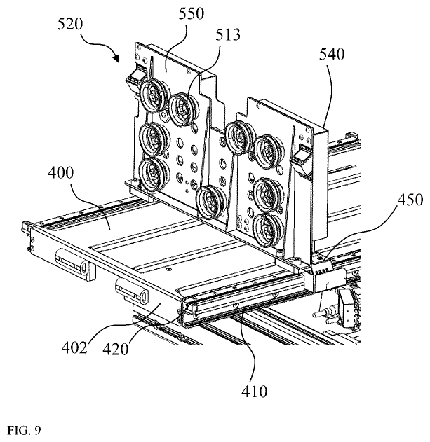

Referring to FIG. 9, in some applications, after the first goods retrieval module 510 is removed from the connection member 450, the second goods retrieval module 520 may be detachably mounted to the connection member 450. The second goods retrieval mechanism is a suction cup assembly. The suction cup assembly includes a pneumatic control assembly and at least one suction cup 513. The suction cup 513 is connected to the pneumatic control assembly. The pneumatic control assembly is configured to control a gas flow state in the suction cup 513, to cause the suction cup 513 to be attached to or detached from a goods container.

The pneumatic control assembly includes a solenoid valve, and gas flow of the suction cup can be controlled by controlling on/off of the solenoid valve. In this embodiment, a rear side of the second mounting bracket 550 further has a cover plate 540 fixed thereto, the pneumatic control assembly is arranged between the second mounting bracket 550 and the cover plate 540, and the cover plate 540 is configured to protect the pneumatic control assembly.

In this embodiment, a plurality of suction cups 513 are arranged. The plurality of suction cups 513 are arranged on a front side of the second mounting bracket 550, and arranged at intervals on the second mounting bracket 550. Openings of the plurality of suction cups 513 are on a same plane, so that the suction cups can be attached to the goods container simultaneously.

In this embodiment, the suction cups 513 are arranged between the two sides of the tray above the tray 400 to be opposite to the goods along the goods moving direction X, so that the suction cups 513 may obtain the goods by operating on a side of the goods facing the goods moving direction X.

In the embodiments of this application, different goods retrieval mechanisms (for example, a goods retrieval mechanism provided with a claw and a goods retrieval mechanism provided with a suction cup) can be replaced on the fork body, which is simple and easy to operate, and can be applicable to scenarios of goods containers with different specifications.

The operating process of retrieving a goods container from a shelving unit and placing a goods container on the shelving unit by the fork apparatus in the embodiments of this application is as follows.

Before the goods retrieval member performs a goods retrieval action, the front end of the tray along the goods moving direction may be directed toward a target storage location by controlling the rotation of the rotating frame of the fork apparatus, and the goods retrieval member is aligned with a goods retrieval portion of the goods (such as a goods container). The goods retrieval portion may be arranged on an end of the goods facing the fork apparatus.

During retrieval of a goods container, in an initial state, the tray 400 is locked to the rotating frame 200. The telescopic driving member 720 drives the synchronous belt 630 to move forward, and the second sliding block 460 moves forward with the synchronous belt 630. When the goods retrieval mechanism moves to a preset position along the stretching direction with the second sliding block 460, the linkage fitting member 470 fixed to the goods retrieval mechanism abuts against the linkage trigger member 821 at the front end of the tray. The linkage trigger member 821 drives the locking member 831 to move away from the rotating frame 200 through the link assembly arranged on the tray; so as to unlock the tray 400 from the rotating frame 200. After the unlocking, the goods retrieval mechanism drives the tray 400 together to continue to stretch forward and stop after reaching a target position (for example, the tray 400 touches a shelving unit, or a distance from the goods is within a preset range). In this case, a goods retrieval member (a suction cup assembly or a claw assembly) of the goods retrieval mechanism 500 is on a front edge of the fork apparatus, and the goods retrieval member of the goods retrieval mechanism 500 starts to perform a goods retrieval action.

When the goods retrieval member of the goods retrieval mechanism is a claw assembly; the goods retrieval portion of the goods may be a handle with a groove on a side of the goods container. When the claw is oriented downward, the groove has an upward opening. During goods retrieval, the claw driving member 511 drives the claw 512 to ascend to the opening of the goods retrieval portion of the goods container and stretch out the claw 512 until the claw is aligned with the opening of the groove, and then drives the claw 512 to descend, to cause the claw 512 to stretch into the groove and cause the claw 512 to be engaged with the handle of the goods container. After the goods retrieval member of the goods retrieval mechanism is stably engaged with the goods container, the telescopic driving member 720 drives the synchronous belt 630 to move backward, and the second sliding block 460 drives the goods retrieval mechanism to move backward with the synchronous belt 630. In other words, the claw 512 moves backward and then pulls the goods container to retract, so that the goods container is pulled onto the tray 400. In this process, the goods container (also referred to as a target goods container) pulled by the claw 512 simultaneously pulls the following goods container to an outermost side of the shelving unit. In this case, the fork apparatus may be controlled to move upward to lift the target goods container, so that the target goods container is separated from the following goods container. During the backward movement of the goods retrieval mechanism, the linkage fitting member 470 is separated from the linkage trigger member 821 at the front end, the tray and the rotating frame are re-locked, and the goods retrieval mechanism pulls the goods container to move backward on the tray 400. After the linkage fitting member 470 continues to move backward and abuts against the linkage trigger member 821 at the rear end of the tray, the tray 400 is unlocked from the rotating frame, and the goods retrieval mechanism drives the tray 400 to retract together.

In some embodiments, after an original position detection switch of the tray senses a signal indicating that the second sliding block 460 moves to the preset position, and a goods container detection switch detects a signal indicating that the goods container moves to the preset position, the telescopic driving member 720 stops moving, and goods container retrieval is completed.

During placement of the goods container, in the initial state, the tray 400 is in an unlocked state with the rotating frame 200. The telescopic driving member 720 drives the goods retrieval mechanism forward through the synchronous belt 630, the goods retrieval mechanism drives the tray 400 to move to a target position (for example, a position where the tray 400 touches the shelving unit) together with the goods container on the tray 400, and the tray is locked to the rotating frame. After the goods retrieval mechanism pushes the goods container to move forward on the tray 400 until the goods container moves onto the shelving unit, the goods retrieval mechanism stops, and the goods retrieval member starts to perform a goods storage action and is disengaged from the goods container. For example, when the goods retrieval member is a claw assembly, the claw driving member drives the claw 512 to ascend, to cause the claw 512 to be disengaged from the handle of the goods container. Then, the telescopic driving member 720 drives the goods retrieval mechanism backward to retract. After the tray 400 is unlocked from the rotating frame, the tray 400 retracts together with the goods retrieval mechanism. When the original position detection switch of the tray senses the signal indicating that the second sliding block moves to the preset position, the telescopic driving member 720 stops moving, and goods container storage is completed.

In some embodiments, a plurality of storage locations are arranged on a same goods layer on the shelving unit along the goods moving direction X for the fork apparatus. The fork apparatus could successively retrieve the goods on the plurality of storage locations through controlling the telescopic length of the telescopic assembly of the fork apparatus.

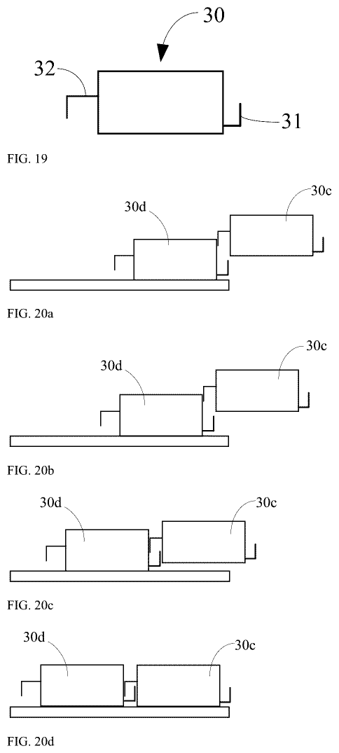

In some embodiments, as shown in FIG. 18, the goods containers 30 on the plurality of storage locations 11 may be engaged with each other in sequence. For example, referring to FIG. 19, one end of the goods container 30 facing the fork apparatus 40, that is, the end facing the outer side of the shelving unit 10, is provided with a goods retrieval portion 31, and an other end facing away from the fork apparatus 40, that is, the end facing the inner side of the shelving unit 10, is provided with a connection part 32 (such as a hooked portion configured to be mated with the handle) configured to be mated with the goods retrieval portion 31. Two adjacent goods containers 30 are connected to each other through the goods retrieval portion 31 arranged on one of the two adjacent goods containers 30 and the connection part 32 arranged on the other one of the two adjacent goods containers 30. After the goods retrieval member 41 of the fork apparatus 40 is engaged with the target goods container 30a stably, the goods retrieval member 41 pulls the target goods container 30a onto the tray 42, and may simultaneously pull the adjacent goods container 30b connected to the target goods container 30a to the outermost side of the shelving unit 10. Then the fork body or the fork apparatus 40 ascends, so that the hooked portion at the end of the target goods container 30a facing away from the fork apparatus 40 is separated from the handle of the adjacent goods container 30b.

During the process of placing the target goods container on the shelving unit, a problem that the target goods container cannot be engaged with the goods container on the adjacent storage location may exist. For example, a first goods container is placed on an outermost storage location, and the target goods container is to be placed on the outermost storage location. During the process of placing, the target goods container may push the first goods container to move to an inner storage location so as to release the outermost storage location for the target goods container. If a movement speed of the telescopic assembly is excessively fast, the target goods container on the telescopic assembly would push the first goods container with an excessively fast movement speed, which may cause the first goods container being knocked away, and the target goods container cannot be engaged with the first goods container. In some embodiments, when the target goods container is about to reach the shelving unit, a movement speed of a telescopic movement mechanism (such as the telescopic assembly) may be reduced in advance, so as to reduce impact force, and to avoid a problem that the adjacent goods container is knocked away because of an excessively fast movement of the goods retrieval mechanism. For example, the goods placing process may include the following steps. The telescopic driving member drives the telescopic assembly to stretch at a first speed. When the target goods container is about to reach the shelving unit-such as when the target goods container reaches a preset position (which may be a certain distance from the shelving unit)—the telescopic driving member drives the telescopic assembly to stretch at a second speed to push the first goods container, originally placed on the outermost storage location, into an inner storage location. The first speed is greater than the second speed.

Similarly, the goods retrieval process may include the following steps. The telescopic driving member drives the telescopic assembly to stretch at a first speed. After a preset position is reached, the telescopic driving member drives the telescopic assembly to stretch at a second speed until the goods retrieval member (such as a claw) reaches a connection portion (such as a groove) of the target goods container. The first speed is greater than the second speed. The remaining goods retrieval steps are similar to the goods retrieval steps in other embodiments of this application. Details are not described herein again.

In some embodiments, during the process of placing the target goods container on the shelving unit, the target goods container is pushed toward the shelving unit by an extra distance, then the fork body is controlled to drive the target goods container to descend, and the target goods container is pushed while descending, so that a pressure is maintained between the target goods container and the adjacent goods container when the hooked portion of the target goods container is hooked into the handle of the adjacent goods container. In this way, a problem that the target goods container does not stretch far enough to reach a position engaged with the adjacent goods container may be avoided. For example, as shown in FIG. 20a-20d, the goods placing process may include the following steps. The telescopic driving member drives the telescopic assembly to stretch toward to the first goods container 30d placed on the outermost storage location. After the target goods container 30c on the telescopic assembly contacts with the first goods container 30d, the fork body would not be controlled to drive the target goods container 30c to descend immediately (as shown in FIG. 20a). The telescopic driving member would drive the telescopic assembly to stretch further toward the first goods container 30d. During this time, the target goods container 30c pushes the first goods container 30d. Then, after the first goods container 30d is pushed for a certain distance (as shown in FIG. 20b), the fork body is controlled to drive the target goods container 30c to descend, and the target goods container 30c pushes the first goods container 30d while descending (as shown in FIG. 20c). After the target goods container 30c is descend to the storage unit 10, the target goods container 30c continues to push the first goods container 30d until the target goods container 30c is completely located in the outermost storage location (as shown in FIG. 20d).

Similarly, the goods retrieval process may include the following steps. The telescopic driving member drives the telescopic assembly to stretch in the direction of the target goods container until the goods retrieval member (such as a claw) touches the target goods container and drives the target goods container to move. When the target goods container is pushed to a preset distance, the telescopic driving member controls the telescopic assembly to continue to stretch, and a driving member (such as a claw driving member) of the goods retrieval member drives the goods retrieval member to descend, so that the goods retrieval member is inserted into the connection portion (such as a groove) of the target goods container. The remaining goods retrieval steps are similar to the goods retrieval steps in other embodiments of this application. Details are not described herein again.

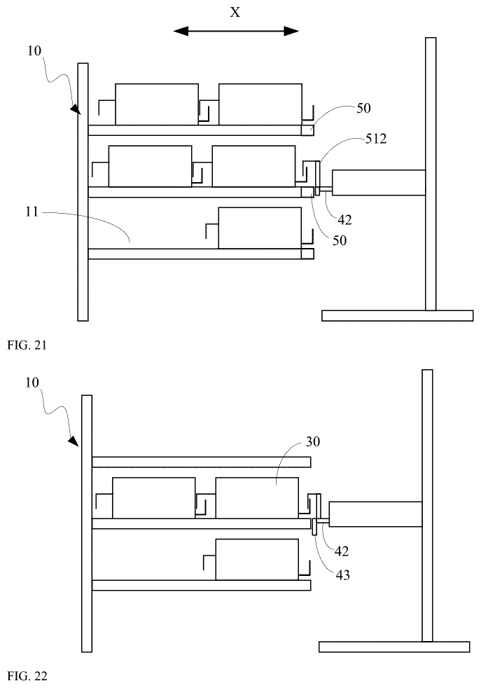

In some embodiments, as shown in FIG. 21, a storage location on each layer of the shelving unit has a beam 50, such as an upper beam and a lower beam, and the upper beam of the storage location on a lower layer may be the lower beam of the storage location on an upper layer. When the goods container 30 is placed on a storage location, the goods container 30 is placed in a position where a side surface of the goods container 30 facing the tray 42 is substantially aligned with a side surface of the lower beam of the storage location facing the tray 42 in a vertical direction. In some embodiments, a push distance error of the telescopic mechanism during goods placing or a vibration or the like may cause the goods container 30 and the beam 50 of the shelving unit 10 to be not flush with each other or deviated greatly. In this case, the claw 512 may be fail to reach the position where the claw 512 is engaged with the goods retrieval portion 31 of the goods container 30. In order to avoid this failure of goods retrieval, the claw 512 may be arranged to be protrude out from the tray 42 by a preset distance in the goods moving direction X, that is, a distance between the claw 512 and the goods container is less than that between the tray 42 and the goods container, especially when the claw 512 is preparing to retrieve the goods container.

In some embodiments, in order to prevent the front end of the tray 400 from pushing the goods container away when the goods retrieval mechanism drives the tray 400 to stretch, a front end surface 402 of the tray 400 may be set to have a preset height in the vertical direction, so that the front end surface 402 of the tray overlaps with the lower beam of the current storage location in a horizontal direction, to ensure that the tray 400 is limited by the lower beam when stretching, and does not push the goods container away. Specifically, referring to FIG. 22, the front end of the tray 400 is provided with an abutting plate 43 configured to abut against a shelving unit 10 (such as the lower beam of the storage location). For example, the abutting plate 43 is approximately perpendicular to the tray 42 and extends downward (away from a side of the tray 400 bearing a goods container). The abutting plate 43 extends downward by the preset height. The preset height satisfies the following condition. During goods retrieval or placing, the tray 42 abuts against the shelving unit 10, and does not enter the shelving unit 10 to push the goods container 30.

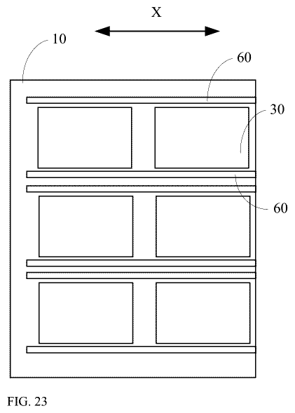

In some embodiments, for example, in a case that a shelving unit code is set while a goods container code is not set, since a position of the goods container on the shelving unit is random, a plurality of deviations exist in the position of the goods container. For example, a deviation of the goods container relative to the shelving unit code in a traveling direction, a deviation relative to the shelving unit code in the non-traveling direction, and an angular deviation relative to the shelving unit code. These deviations make it difficult for the claw 512 to be accurately engaged with the handle of the goods container. Referring to FIG. 23, a guide bar 60 extending along the goods moving direction X may be arranged on the shelving unit 10. The guide bar 60 can limit the deviation and the angular deviation of the goods container 30 relative to the shelving unit code in the goods moving direction X when placing goods. Alternatively, a groove space of the handle of the goods container may be arranged to be large enough, so that the claw 512 can also be engaged with the handle in a case that the position of the goods container has the foregoing deviations. Alternatively, a guide structure may be arranged on the claw 512. The guide structure can help the claw 512 be hooked into the handle of the goods container.

In some embodiments, the rotating frame 200 is equipped with a drag chain bracket thereon, and the drag chain bracket is equipped with a telescopic drag chain thereon. A wiring harness is arranged in the telescopic drag chain. A fixed end of the telescopic drag chain is fixedly mounted to the drag chain bracket, a moving end of the telescopic drag chain is fixed to a drag chain support member, and the drag chain support member is fixed to the second sliding block 460, so that a telescopic function of the wiring harness can be met when the tray 400 and the goods retrieval mechanism are in operation.

According to the solutions provided in the embodiments, retrieval and placing of different types of goods containers can be achieved by replacing different goods retrieval mechanisms. The goods retrieval mechanism may adopt a suction cup assembly or a claw assembly. All of the suction cups and the claws can operate on a surface of the goods container (for example, a front surface facing the fork assembly). Since shelving units in a warehouse are generally placed back to back, a distance between the back-to-back fitted goods containers is reduced, thereby increasing a density of the goods containers.

In addition, the goods retrieval mechanism is configured to retrieve or place goods through operating only on the front surface of the goods container facing the fork assembly, and a goods retrieval manipulator could be omitted from the fork apparatus. Therefore, a space occupied by the goods retrieval manipulator at the back of the goods container is also saved, and the problem of insufficient storage density of the goods containers caused by retrieval or placing of the fork by clamping and lifting based on a size of the largest goods container in the related art is also avoided while reducing the distance between the back-to-back fitted goods containers.

The fork apparatus in the embodiments of this application is described above. Correspondingly, this application further provides a warehousing robot.

FIG. 10 is a schematic structural diagram of a warehousing robot according to an embodiment of this application.

Referring to FIG. 10, a warehousing robot 900 provided in this embodiment of this application includes a robot body and a fork apparatus 940 arranged on the robot body. The fork apparatus 940 has the features of the foregoing embodiments. Details are not described herein again.

The warehousing robot 900 in this embodiment includes a chassis 910 and a lifting mechanism 920 arranged on the chassis 910. The fork apparatus 940 is mounted to the lifting mechanism 920, and can ascend or descend along the lifting mechanism 920. A side of the lifting mechanism 920 is provided with a storage shelving unit. The storage shelving unit has a plurality of storage areas 930 in a vertical direction.

In some embodiments, an initial angle of a rotating frame of the fork apparatus 940 is for example 0 degrees relative to a moving direction of the chassis 910. When the fork apparatus 940 ascends or descends to a position aligned with one of the storage areas 930 in the vertical direction, a telescopic transmission mechanism 600 is controlled to drive a goods retrieval mechanism to stretch or retract, so that a goods container may be placed in the storage area 930 or retrieved from the storage area 930.

When goods need to be taken from or placed on a shelving unit, before the goods retrieval member performs a goods retrieval or placing action, a rotating frame 200 of the fork apparatus 940 is controlled to rotate forward by a preset angle (for example, be at 90 degrees relative to the moving direction of the base chassis), so that a front end of a tray 400 along a goods moving direction X faces a target storage location, and the goods retrieval member is aligned with a goods retrieval portion of the goods container. In some embodiments, relative positions of the fork apparatus and a shelving unit code may be fine-tuned by reading the shelving unit code.

When the fork apparatus 940 needs to move goods borne on the tray 400 to the storage area 930, the lifting mechanism 920 moves the fork apparatus 940 to be aligned with the storage area 930 in the vertical direction, and the rotating frame 200 rotates reversely by a preset angle to return to an initial angle state. The telescopic transmission mechanism 600 drives the goods retrieval mechanism to move forward, and a push plate of a claw assembly can push the goods container 941 into the storage area 930. When the goods container 941 is completely pushed into the storage area 930, a claw driving member drives a claw 512 to ascend, so that the claw 512 is disengaged from a handle of the goods container. In this case, the process of goods container placing is completed. Then the telescopic transmission mechanism 600 drives the goods retrieval mechanism to retract, so that the fork apparatus returns to the initial state for next goods retrieval or placing. If the plurality of storage areas need to be filled, the foregoing steps are repeated.

The warehousing robot 900 in this embodiment may further be applied to a conveyor, a temporary storage shelving unit, or docking with an automatic loading/unloading machine to take or place goods.

In some embodiments, the warehousing robot 900 is configured to place goods on the conveyor or the temporary storage shelving unit. After the warehousing robot 900 moves to an area of the conveyor through the chassis 910 based on a received goods placing instruction, the lifting mechanism 920 of the warehousing robot 900 drives the fork apparatus 940 to ascend or descend to a height where the storage area 930 on a certain layer is located, and the goods retrieval mechanism retrieves a goods container from the storage area 930 and places the goods container on the tray 400, and then adjusts a position of the tray 400 to push the goods container on the tray 400 into the conveyor or a storage location of the temporary storage shelving unit. The foregoing process may be repeated to transfer all of the goods containers in the storage area 930 on each layer to the conveyor or the temporary storage shelving unit.

In some embodiments, the warehousing robot 900 is configured to retrieve goods from the conveyor or the temporary storage shelving unit. After the warehousing robot 900 moves to a docking area of the conveyor or the temporary storage shelving unit through the chassis 910 based on the received goods retrieval instruction, the lifting mechanism 920 drives the fork apparatus 940 to move to a preset docking height, and the rotating frame rotates to cause the front end of the tray to face the goods container. According to read information of an identification code of a corresponding position, the relative positions of the fork apparatus 940 and the identification code are adjusted, so that the goods retrieval mechanism can smoothly retrieve and place the goods container on the tray 400 and in the storage area 930.

An example in which the claw is oriented downward and a groove on the goods container has an upward opening is used to describe the goods retrieval and storage process in this embodiment below.

During the process of retrieving goods, the lifting mechanism drives the fork apparatus (including the claw) to ascend or descend until the claw is located above a groove of a target goods container. In this case, a horizontal position of the tray may be higher than a horizontal position of the bottom of the target goods container. The telescopic driving member drives the telescopic assembly to stretch, so that the claw stretches until the claw is located above the opening of the groove. The lifting mechanism drives the fork apparatus to descend until the claw is inserted into the groove from the opening of the groove of the target goods container. In this case, the horizontal position of the tray is flush with the horizontal position of the bottom of the target goods container. The telescopic driving member drives the telescopic assembly to retract, so that the claw retracts until the target goods container enters the tray. In this case, since a hooked portion of the target goods container is hooked into a handle of a goods container (if any) located behind the target goods container, the goods container located behind the target goods container is pulled to an original position of the target goods container. The lifting mechanism drives the fork apparatus to ascend again, so that the target goods container on the tray ascends, and then the hooked portion of the target goods container is disengaged from the handle of the goods container located behind the target goods container, thereby realizing the goods retrieval.

During the process of goods placing, the lifting mechanism drives the fork apparatus (including the claw) to ascend or descend until the hooked portion of the target goods container is above a handle of a goods container in the target storage location. In this case, the horizontal position of the tray is higher than the horizontal position of the target storage location. The lifting mechanism drives the fork apparatus to descend, so that the hooked portion of the target goods container is inserted into the handle of the goods container in the target storage location. In this case, the horizontal position of the tray is flush with the horizontal position of the target storage location. The telescopic driving mechanism drives the telescopic assembly to drive the first mounting bracket to stretch, so that the first mounting bracket pushes the target goods container from the tray to the target storage location, and at the same time, the target goods container pushes the goods container in the target storage location to a deeper storage location. When the target goods container is completely placed in the target storage location, the lifting mechanism drives the fork apparatus to ascend again, and the claw is disengaged from the groove of the target goods container.

FIG. 11 is a simplified schematic structural diagram of a transport robot 1100 according to an embodiment of this application. Referring to FIG. 11, the transport robot 1100 in this embodiment includes a movable base 1110, a lifting mechanism 1120 arranged on the movable base 1110, and a bearing apparatus 1130 arranged on the lifting mechanism 1120. The bearing apparatus 1130 may be a bearing plate, a tray; or the fork apparatus described in the foregoing embodiments. It may be understood that, in some other embodiments, the transport robot may not include the lifting mechanism, and the bearing apparatus 1130 may be arranged on the movable base 1110.

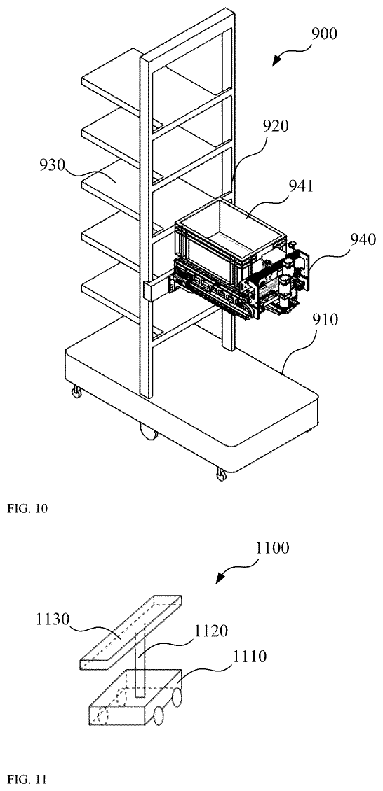

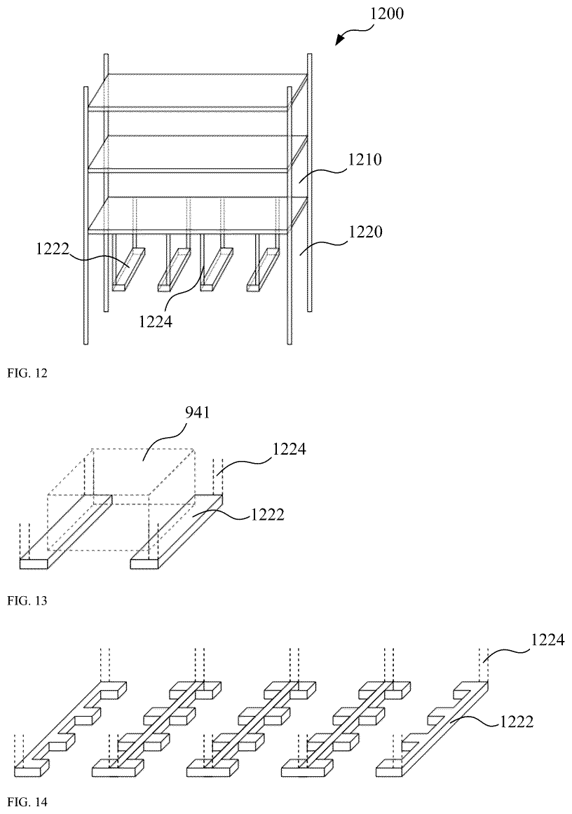

Referring to FIG. 12 and FIG. 13, in some embodiments, a shelving unit 1200 has a high-level storage space 1210 and a low-level temporary storage space 1220. The low-level temporary storage space 1220 may be configured for temporary storage of a goods container in a suspended temporary storage location. For example, a temporary storage layer of the temporary storage space 1220 is provided with a plurality of supporting plates 1222 arranged at intervals. A length direction of the supporting plates 1222 is along a width direction of the shelving unit, that is, a depth direction of the shelving unit. A temporary storage location is formed between adjacent supporting plates 1222, and two sides of a goods container 941 may be respectively supported by two adjacent supporting plates 1222. The supporting plate 1222 is suspended on a bottom-level goods plate of the storage space 1210 through a suspension component 1224. The suspension component 1224 may be, for example, a suspension rod or a suspension chain, and is fixed to the bottom-level goods plate through hole location locking, welding, or another form.

In an exemplary specific application, the goods container 941 is transferred between the storage space 1210 and the temporary storage space 1220 of the shelving unit 1200 through a goods container transport robot (for example, the goods container transport robot may be, but not limited to, the warehousing robot 900 shown in FIG. 10), and the goods container 941 is transferred between the temporary storage space 1220 and a target site of the warehouse through a transport robot (for example, the transport robot may be, but not limited to, the transport robot 1100 shown in FIG. 11). During goods retrieval, the transport robot 1100 may walk from any side of the shelving unit 1200 to the middle of two adjacent supporting plate 1222 along the length direction of the supporting plates 1222, the bearing apparatus 1130 lifts the goods container 941 from the bottom, and then the transport robot 1100 moves the goods container 941 out from any side of the shelving unit 1200 along the length direction of the supporting plates 1222, and transports the goods container to the target site. Similarly, the transport robot 1100 may walk from any side of the shelving unit 1200 to the middle of two adjacent supporting plates 1222 to complete goods placing. Since the supporting plates 1222 are suspended, the temporary storage space 1220 may not be provided with a beam, to prevent the beam from interfering with the movement of the transport robot. The transport robot may take or place goods from or on any side of the shelving unit 1200. Therefore, the transport robot has a larger degree of freedom of movement and more scheduling space, thereby improving overall efficiency of a system.

FIG. 14 shows another implementation of a suspended temporary storage layer. The temporary storage layer is provided with a plurality of supporting plates 1222 arranged at intervals. Adjacent temporary storage spaces share a supporting plate 1222. The supporting plate 1222 is serrated. In this way, the number of supporting plates required may be reduced, a weight of supporting plate may be reduced, and materials may be saved.

In some embodiments, referring to FIG. 15, a temporary storage layer of a temporary storage space 1220 of a shelving unit 1200 may be in a different form from that in FIG. 12. Specifically, the temporary storage layer is provided with a plurality of supporting plates 1222 arranged at intervals. A length direction of the supporting plates 1222 is along a width direction of the shelving unit. A temporary storage location is formed between adjacent supporting plates 1222, and a goods container 941 may be placed between two adjacent supporting plates 1222. Same sides of the plurality of supporting plates 1222 are connected as a whole through a beam 1226, and are fixedly mounted to the shelving unit through the beam 1226. The transport robot may take or place goods from or on an other side of the shelving unit 1200. The temporary storage layer in this embodiment may be referred to as a beam-mounted temporary storage layer.

It may be understood that the suspended temporary storage location may further be configured for temporary storage of the goods container through hooks and the like.

In some embodiments, a warehousing system is provided with a plurality of shelving units at intervals, and an aisle is formed between adjacent shelving units. A length direction of the shelving unit is parallel to a length direction of the aisle. The plurality of shelving units may all be shelving units with suspended temporary storage layers, or may all be shelving units with beam-mounted temporary storage layers, or a combination of the two types of shelving units may be used.

In some embodiments, the warehousing system is an intelligent sorting system, a goods container transport robot transports a goods container stored in a storage space of the shelving unit to the temporary storage space for temporary storage, and the transport robot transports the temporarily stored goods container to a picking workstation, so that a picker sorts materials in the goods container into an order container.

In a specific example, each shelving unit among a plurality of shelving units arranged at intervals of the intelligent sorting system is provided with a low-level temporary storage layer. For example, a low-level position corresponding to each high-level storage location is provided with at least one low-level temporary storage location. In other words, each high-level storage location corresponds to at least one low-level temporary storage location. In other words, all low-level layers of the shelving units are all provided with temporary storage locations. At least part of the low-level temporary storage layers of the shelving units are suspended temporary storage layers. In some embodiments, the low-level temporary storage layers of all the shelving units are all suspended temporary storage layers. In some other embodiments, the shelving units at both ends may be the shelving units with beam-mounted temporary storage layers, and some or all of the shelving units between the shelving units at both ends may be the shelving units with suspended temporary storage layers. Compared with use of all the shelving units with beam-mounted temporary storage layers, the introduction of the shelving units with suspended temporary storage layers may cause the low-level layers of the shelving units to be all provided with temporary storage locations, without reserving space without temporary storage locations for the movement of the transport robot. The transport robot may move in a space corresponding to the suspended temporary storage space. Therefore, the transport robot has a greater degree of freedom of movement and more scheduling space. The space for the transport robot to move is increased, which helps shorten a transport distance of the transport robot and reduces a possibility of blockage, thereby improving efficiency of the sorting system.

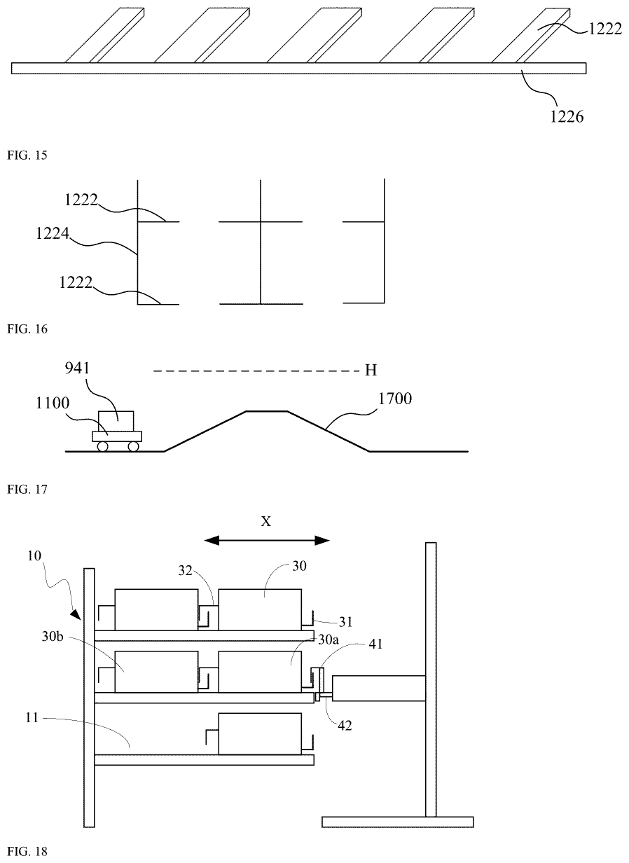

In some embodiments, when a high-level storage location corresponds to a plurality of low-level temporary storage locations, the corresponding low-level temporary storage locations may be arranged along a vertical direction. In other words, the low-level temporary storage layers may include a plurality of layers. Referring to FIG. 16, the temporary storage space of the shelving unit is provided with a plurality of temporary storage layers. Each temporary storage layer is provided with a plurality of supporting plates 1222 arranged at intervals. At least part of the supporting plates 1222 on different temporary storage layers are correspondingly arranged in a height direction, and the corresponding supporting plates 1222 on different temporary storage layers are connected as a whole through the suspension component 1224, and suspended on the bottom-level goods plate of the storage space. The transport robot may take or place goods from or on any temporary storage layer by adjusting a height of the lifting mechanism.

In the intelligent sorting system of some embodiments, referring to FIG. 17, the transport robot 1100 transports the goods container 941 to the picking workstation, and may move along a ramp 1700 arranged in the picking workstation and stop at a preset site. The ramp is arranged such that at a preset picking location, a picker may directly pick the goods containers on the transport robot without bending over. The ramp 1700 may have an ascending slope section, a descending slope section, or may have a flat top section. Each section may include a planar section, a curved section, and/or the like. It may be understood that the set picking height H may not be fixed, and may be set based on a height of the transport robot, a height of the goods container, a height of the picker, and/or the like. In some embodiments, the transport robot 1100 moves along the ramp 1700 and stops until the height of the goods container reaches a set picking height H, so that the picker directly picks the goods containers on the transport robot. A ramp is arranged in the picking workstation, which helps quickly supply the goods containers to the picking location, without the need to unload the goods containers from the transport robot or control the transport robot to ascend or descend, and without the need to additionally dispatch the transport robot to take away the picked goods containers after the picking, thereby reducing system control difficulty.

In the intelligent sorting system of some embodiments, after the transport robot transports the goods container to the picking workstation, the goods container may also be moved to a liftable operating platform arranged in the picking workstation. Then, the liftable operating platform is controlled to ascend, so that the height of the goods container may be adjusted to a picking height of the picker. In this embodiment, occupation of the transport robot by the picking workstation may be reduced to improve turnover efficiency of the transport robot.

In some embodiments, when docking with an automatic loading/unloading machine, the warehousing robot 900 moves, through the chassis 910 based on a received instruction, to an area where the automatic loading/unloading machine is located, and then controls the fork apparatus 940 to move to a specified position and angle. A manipulator of the automatic loading/unloading machine transports a goods container from the storage area 930, or transports a goods container in another position to the storage area 930.

It may be understood that during application to a conveyor, a temporary storage shelving unit, or docking with an automatic loading/unloading machine, for the specific process of taking or placing goods by the fork apparatus, reference may be made to the description of the foregoing embodiments. Details are not described herein again.

The embodiments of this application have been described above. The above description is exemplary, non-exhaustive, and is not limited to the disclosed embodiments. Many modifications and changes are apparent to a person of ordinary skill in the art without departing from the scope and spirit of the described embodiments. The selection of the terms used herein is intended to best explain the principles of the embodiments, practical applications, or technical improvements in the market, or to enable another person of ordinary skill in the art to understand the embodiments disclosed herein.

1. A fork apparatus, comprising:
a fork body, comprising a base, a tray, and a telescopic assembly, wherein the tray is supported by the base, and the telescopic assembly comprises a connection member that is stretchable or retractable relative to the tray along a goods moving direction; and
a goods retrieval mechanism being detachably mounted to the connection member;
wherein the goods retrieval mechanism comprises:
a first goods retrieval mechanism comprising a first goods retrieval member that is configured to operate on goods in a first manner; or
a second goods retrieval mechanism comprising a second goods retrieval member that is configured to operate on the goods in a second manner different from the first manner.

2. The fork apparatus according to claim 1, wherein
the first goods retrieval mechanism comprises a claw assembly; or
the second goods retrieval mechanism comprises a suction cup assembly.

3. The fork apparatus according to claim 1, wherein
the first goods retrieval member or the second goods retrieval member is configured to operate on a surface of the goods facing a single direction.

4. The fork apparatus according to claim 1, wherein
the first goods retrieval member is configured to operate on a surface of the goods facing a single direction, and the second goods retrieval member is configured to operate on surfaces of the goods facing at least two directions respectively.

5. The fork apparatus according to claim 1, further comprises a telescopic transmission mechanism connected to the base, and a telescopic driving member connected to the telescopic transmission mechanism;
wherein two telescopic assemblies are arranged, and the two telescopic assemblies are respectively arranged on two sides of the tray;
wherein each of the telescopic assemblies is driven by the telescopic driving member through the telescopic transmission mechanism;
wherein two telescopic transmission mechanisms are respectively arranged on the two sides of the tray, and are synchronously driven by a single telescopic driving member.

6. The fork apparatus according to claim 1,
wherein the fork apparatus further comprises a first mounting bracket and a second mounting bracket;
the first goods retrieval mechanism is detachably mounted to the first mounting bracket, the second goods retrieval mechanism is detachably mounted to the second mounting bracket, and the first mounting bracket and the second mounting bracket are each provided with a mounting portion mated with the connection member; or
wherein the fork apparatus further comprises a third mounting bracket;
at least one of the first goods retrieval mechanism and the second goods retrieval mechanism is detachably mounted to the third mounting bracket, and the third mounting bracket is provided with a mounting portion mated with the connection member.

7. The fork apparatus according to claim 5,
wherein the telescopic assembly comprises a second guide rail arranged along the goods moving direction, and a second sliding member in sliding fit with the second guide rail;
wherein the connection member is connected to the second sliding member, and the connection member is slidably connected to the tray through the second sliding member.

8. The fork apparatus according to claim 7, wherein
the telescopic transmission mechanism comprises a belt transmission mechanism, the belt transmission mechanism comprises a telescopic driving wheel, a telescopic driven wheel, and a synchronous belt wound around the telescopic driving wheel and the telescopic driven wheel, the telescopic driving wheel is connected to an output shaft of the telescopic driving member, a linear operation portion moving along the goods moving direction is formed on the synchronous belt, and the second sliding member is connected to the linear operation portion.

9. The fork apparatus according to claim 1,
wherein the telescopic assembly comprises a first guide rail and a second guide rail arranged in parallel along the goods moving direction, a first sliding member in sliding fit with the first guide rail, and a second sliding member in sliding fit with the second guide rail;
wherein the tray is slidably connected to the base through the first guide rail and the first sliding member, and the connection member is slidably connected to the tray through the second guide rail and the second sliding member.

10. The fork apparatus according to claim 1,
wherein a linkage assembly is arranged between the goods retrieval mechanism and the tray, the goods retrieval mechanism drives the tray to stretch or retract through the linkage assembly during stretching or retracting;
wherein the linkage assembly comprises two linkage trigger members arranged on the tray; and a linkage fitting member fixedly arranged relative to the goods retrieval mechanism; and
wherein the two linkage trigger members are respectively arranged on two ends of the tray along the goods moving direction, the linkage fitting member is located between the two linkage trigger members, and when moving to a preset position along a stretching or retraction direction with the goods retrieval mechanism, the linkage fitting member is configured to abut against a corresponding linkage trigger member to drive the tray to stretch or retract.

11. The fork apparatus according to claim 10,
further comprising a locking mechanism arranged between the tray and the base;
wherein the locking mechanism comprises a link assembly arranged on the tray and a locking member arranged on the link assembly, the locking member is configured to be locked to or separated from the base, the two linkage trigger members are arranged on the link assembly, and when abutting against each of the two linkage trigger members, the linkage fitting member drives the link assembly to move along the stretching or retraction direction, to cause the locking member to be locked to or separated from the base.

12. The fork apparatus according to claim 11,
further comprising an unlocking trigger member, wherein the unlocking trigger member is in transmission fit with the locking mechanism, and when the goods retrieval mechanism pulls the goods to touch the unlocking trigger member, the unlocking trigger member drives the locking mechanism to move, to cause the locking member to be unlocked from the base.

13. The fork apparatus according to claim 11, wherein
the base is provided with a toothed engagement plate, the toothed engagement plate is provided with several engagement teeth along the goods moving direction, and when the linkage fitting member drives the link assembly to move along the stretching or retraction direction, the link assembly drives the locking member to move in a direction close to or away from the toothed engagement plate along a direction forming an included angle with the goods moving direction, so that the locking member is engaged between two adjacent engagement teeth or disengaged from the engagement teeth.

14. The fork apparatus according to claim 11, wherein
the link assembly comprises a first link, a second link, a third link, and a fourth link rotatably connected in sequence, the first link is fixed to the tray; the two linkage trigger members are respectively arranged on the second link and the fourth link, and the locking member is arranged on the first link and the third link; and
lengths of the first link and the third link are greater than lengths of the second link and the fourth link.

15. The fork apparatus according to claim 6, wherein
the first goods retrieval mechanism comprises a claw assembly; and
the claw assembly comprises at least one claw, the claw is directly connected to the first mounting bracket and located between two sides of the tray, and the claw faces the goods along the goods moving direction.

16. The fork apparatus according to claim 1, wherein
the first goods retrieval mechanism comprises a claw assembly;
the claw assembly comprises a claw driving member and at least one claw, the at least one claw is connected to an output shaft of the claw driving member;
the claw is arranged between the two sides of the tray and above the tray, and the claw faces the goods along the goods moving direction; and
the claw driving member is configured to drive the claw to ascend or descend along a vertical direction, to cause the claw to be engaged with or disengaged from the goods.

17. The fork apparatus according to claim 1, wherein
the second goods retrieval mechanism comprises a suction cup assembly;
the suction cup assembly comprises a pneumatic control assembly and at least one suction cup, the at least one suction cup is connected to the pneumatic control assembly, and the pneumatic control assembly is configured to control a gas flow state in the at least one suction cup, to cause the suction cup to be attached to or detached from a goods container; and
the suction cup is arranged between the two sides of the tray and above the tray, and the suction cup faces the goods along the goods moving direction.

18. The fork apparatus according to claim 1, wherein
the base comprises a fixing base and a rotating frame, the rotating frame is rotatably mounted to the fixing base, and the tray and the telescopic assembly are mounted to the rotating frame;
wherein the fork apparatus further comprises a rotating driving member connected to the rotating frame, and a rotational transmission mechanism connected to the rotating driving member and the rotating frame;
wherein the rotating frame is driven by the rotating driving member through the rotational transmission mechanism;
wherein the rotational transmission mechanism comprises a rotating member, a rotating driving wheel, a rotating driven wheel, and a transmission member wound around the rotating driving wheel and the rotating driven wheel, and the rotating frame and the fixing base are connected through the rotating member; and
wherein the rotating driving wheel is fixed to an output shaft of the rotating driving member, and the rotating driven wheel is fixedly arranged relative to the rotating frame and coaxially arranged with the rotating member.

19. The fork apparatus according to claim 18,
wherein the rotating frame comprises a rotating support plate, two fixing plates arranged on two sides of the rotating support plate, and a mounting frame arranged on an end of the rotating support plate away from the goods along the goods moving direction;
wherein each of the fixing plates is correspondingly equipped with the telescopic assembly, and the rotating support plate is rotatably mounted to the fixing base; or
wherein the rotating driving member and the telescopic driving member for driving the telescopic assembly are mounted to the mounting frame, the mounting frame is further provided with a control apparatus, and the rotating driving member and the telescopic driving member are electrically connected to the control apparatus.

20. A warehousing robot, comprising:
a chassis, and
a fork apparatus arranged on the chassis;
wherein the fork apparatus comprises:
a fork body;
a first goods retrieval mechanism configured to operate on a goods container to retrieve or place the goods container in a first manner; and
a second goods retrieval mechanism configured to operate on a goods container to retrieve or place the goods container in a second manner;
wherein the first manner is different from the second manner, and the first goods retrieval mechanism and the second goods retrieval mechanism are interchangeably installed on the fork body.
